(19) United States
(12) Patent Application Publication
(10) Pub. No.: US 2023/0244229 A1
(43) Pub. Date: Aug. 3, 2023

(54) Systems, Methods, and Media for Selecting Actions to be Taken By a Reinforcement Learning Agents

(71) Applicants: Matei Ciocarlie, New York, NY (US); Shuran Song, New York, NY (US)

(72) Inventors: Matei Ciocarlie, New York, NY (US); Shuran Song, New York, NY (US)

(21) Appl. No.: 18/103,426

(22) Filed: Jan. 30, 2023

Related U.S. Application Data
(60) Provisional application No. 63/304,696, filed on Jan. 30, 2022.

(51) Int. Cl. G05D 1/00

(52) U.S. Cl. CPC G05D 1/0088

(57) ABSTRACT

Mechanism for selecting an action to be taken by a reinforcement learning agent in an environment, including: determining a first variance for a first state of the environment, wherein the first variance is based on reinforcement learning using a hardware processor; determining that the first variance meets a threshold; in response to determining that the first variance meets the threshold: requesting an identification of a first action to be taken by the agent from a human; and receiving the identification of the first action; and causing the first action to be taken by the agent.

### CROSS REFERENCE TO RELATED APPLICATION

This application claims the benefit of U.S. Provisional Pat. Application No. 63/304,696, filed Jan. 30, 2022, which is hereby incorporated by reference herein in its entirety.

### BACKGROUND

Reinforcement learning has shown success with complex problems both in research as well as commercial settings. Current reinforcement learning policies are great at learning policies for fairly complex problems in a deterministic environment. However, some sets of problems are so complex that a reinforcement learning agent will not be able to always interact with the environment optimally.

Accordingly, new mechanisms for selecting actions to be taken by a reinforcement learning agent as desirable.

### SUMMARY

In accordance with some embodiments, systems, methods, and media for selecting actions to be taken by a reinforcement learning agent are provided.

In some embodiments, systems for selecting an action to be taken by a reinforcement learning agent in an environment are provided, the systems comprising: a memory; and a hardware processor coupled to the memory and configured to at least: determine a first variance for a first state of the environment, wherein the first variance is based on reinforcement learning; determine that the first variance meets a threshold; in response to determining that the first variance meets the threshold: request an identification of a first action to be taken by the agent from a human; and receive the identification of the first action; and cause the first action to be taken by the agent. In some of these embodiments, the hardware processor is also configured to: determine a second variance for a second state of the environment, wherein the second variance is based on reinforcement learning; determine that the second variance does not meet the threshold; in response to determining that the second variance does not meet the threshold: select a second action to be taken by the agent based on a reinforcement learning policy; and cause the second action to be taken by the agent. In some of these embodiments, the agent is an autonomous vehicle. In some of these embodiments, the agent is a robot.

In some embodiments, systems for selecting an action to be taken by a reinforcement learning agent in an environment are provided, the systems comprising: a memory; and a hardware processor coupled to the memory and configured to at least: select a first action to be taken by the agent based on a reinforcement learning policy; determine that the first action is to request an action selection from a human; in response to determining that the first action is to request an action selection from a human: request an identification of a new first action to be taken by the agent from a human; and receive the identification of the new first action; and cause the new first action to be taken by the agent. In some of these embodiments, the hardware processor is also configured to: select a second action to be taken by the agent based on the reinforcement learning policy; determine that the second action is not to request an action selection from a human; in response to determining that the second action is not to request an action selection from a human: cause the second action to be taken by the agent. In some of these embodiments, the agent is one of an autonomous vehicle and a robot.

In some embodiments, methods for selecting an action to be taken by a reinforcement learning agent in an environment are provided, the methods comprising: determining a first variance for a first state of the environment, wherein the first variance is based on reinforcement learning using a hardware processor; determining that the first variance meets a threshold; in response to determining that the first variance meets the threshold: requesting an identification of a first action to be taken by the agent from a human; and receiving the identification of the first action; and causing the first action to be taken by the agent. In some of these embodiments, the methods further comprise: determining a second variance for a second state of the environment, wherein the second variance is based on reinforcement learning; determining that the second variance does not meet the threshold; in response to determining that the second variance does not meet the threshold: selecting a second action to be taken by the agent based on a reinforcement learning policy; and causing the second action to be taken by the agent. In some of these embodiments, the agent is an autonomous vehicle. In some of these embodiments, the agent is a robot.

In some embodiments, methods for selecting an action to be taken by a reinforcement learning agent in an environment are provided, the methods comprising: selecting a first action to be taken by the agent based on a reinforcement learning policy using a hardware processor; determining that the first action is to request an action selection from a human; in response to determining that the first action is to request an action selection from a human: requesting an identification of a new first action to be taken by the agent from a human; and receiving the identification of the new first action; and causing the new first action to be taken by the agent. In some of these embodiments, the methods further comprise: selecting a second action to be taken by the agent based on the reinforcement learning policy; determining that the second action is not to request an action selection from a human; in response to determining that the second action is not to request an action selection from a human: causing the second action to be taken by the agent. In some of these embodiments, the agent is one of an autonomous vehicle and a robot.

In some embodiments, non-transitory computer-readable media containing computer executable instructions that, when executed by a processor, cause the processor to perform a method for selecting an action to be taken by a reinforcement learning agent in an environment are provided, the method comprising: determining a first variance for a first state of the environment, wherein the first variance is based on reinforcement learning; determining that the first variance meets a threshold; in response to determining that the first variance meets the threshold: requesting an identification of a first action to be taken by the agent from a human; and receiving the identification of the first action; and causing the first action to be taken by the agent. In some of these embodiments, the method further comprises: determining a second variance for a second state of the environment, wherein the second variance is based on reinforcement learning; determining that the second variance does not meet the threshold; in response to determining that the second variance does not meet the threshold: selecting a second action to be taken by the agent based on a reinforcement learning policy; and causing the second action to be taken by the agent. In some of these embodiments, the agent is an autonomous vehicle. In some of these embodiments, the agent is a robot.

In some embodiments, non-transitory computer-readable media containing computer executable instructions that, when executed by a processor, cause the processor to perform a method for selecting an action to be taken by a reinforcement learning agent in an environment are provided, the method comprising: selecting a first action to be taken by the agent based on a reinforcement learning policy; determining that the first action is to request an action selection from a human; in response to determining that the first action is to request an action selection from a human: requesting an identification of a new first action to be taken by the agent from a human; and receiving the identification of the new first action; and causing the new first action to be taken by the agent. In some of these embodiments, the method further comprises: selecting a second action to be taken by the agent based on the reinforcement learning policy; determining that the second action is not to request an action selection from a human; in response to determining that the second action is not to request an action selection from a human: causing the second action to be taken by the agent. In some of these embodiments, the agent is one of an autonomous vehicle and a robot.

### BRIEF DESCRIPTION OF THE DRAWINGS

FIG. 1 is an example illustration of a process for training a reinforcement learning policy in accordance with some embodiments.

FIG. 2 is an example illustration of a process for run-time selection and taking of actions to be taken by a reinforcement learning agent using the policy learned in FIG. 1 in accordance with some embodiments.

FIG. 3 is an example illustration of another process for training a reinforcement learning policy in accordance with some embodiments.

FIG. 4 is an example illustration of a process for run-time selection and taking of actions to be taken by a reinforcement learning agent using the policy learned in FIG. 3 in accordance with some embodiments.

FIG. 5 is an example illustration of hardware that can be used in accordance with some embodiments.

### DETAILED DESCRIPTION

In accordance with some embodiments, new mechanisms (including systems, methods, and media) for selecting actions to be taken by a reinforcement learning agent are provided. In some embodiments, these mechanisms can request and receive a selection of action to be taken by a reinforcement learning agent from a human expert (which can be any person deemed to have suitable expertise), and determine when it is best to do same.

In some embodiments, these mechanisms can be used in any suitable application in which a reinforcement learning policy is used to select actions to be taken by a reinforcement learning agent and in which the cost associated with an incorrect selection at certain points in time is high enough to justify human intervention. For example, with reinforcement learning agents that are automated vehicles and robots, an incorrect action selection can cause a human to be injured or killed and/or an automated vehicle, a robot, and/or other property to be damaged or destroyed. As a more particular example, consider a robot in logistics automation, handling merchandise. When it has to handle a novel item, one that it does not have a lot of experience with, it can realize that there is a high risk to drop it and/or package it incorrectly and can call for help. As another more particular example, consider a robot on a manufacturing line performing assembly. When parts are fed to the robot in an unusual fashion, it can recognize there is a high risk of the assembly being incorrect, and can calling for help. By requesting and receiving human intervention when such a scenario is possible, the mechanisms described herein greatly improve mechanisms that select actions to be taken by reinforcement learning agents.

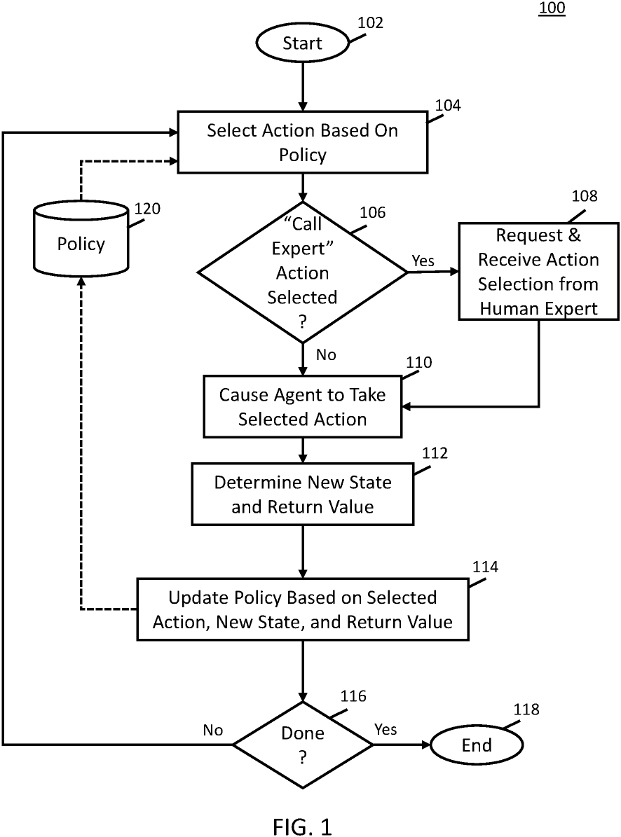

Turning to FIG. 1, an example 100 of a process for training a reinforcement learning policy in accordance with some embodiments is illustrated. As shown, after process 100 begins at 102, the process selects an action to be taken by a reinforcement learning agent based on a current state of an environment in which the agent is present according to a policy 120 at 104. Any suitable action can be selected in accordance with policy 120, and any suitable policy 120 can be used (e.g., such as a manually defined initial policy), in some embodiments. For example, in some embodiments, the action selected can be an action to “call expert” or any other suitable action as appropriate for the environment.

Next, at 106, process 100 can determine whether a “call expert” action was selected at 104. The determination can be made in any suitable manner in some embodiments.

If it is determined at 106 that a “call expert” action was selected at 104, then, at 108, process 100 can request and receive a new action selection from a human expert. This request and receipt can be performed in any suitable manner in some embodiments. For example, in some embodiments, information on the current state of the environment, past states of the environment, policy information, available actions, and/or any other suitable information can be provided to a human expert via any suitable mechanism (e.g., help desk software), the human expert can select one of the available actions via any suitable mechanism (e.g., help desk software), after which an identification of the new selected action can be returned to process 100 for receipt.

After receiving the new action selection at 108 or determining at 106 that a “call expert” action was not selected at 104, at 110, process 100 can next cause the agent to take the action received at 108, if an expert was called, or the action selected at 104, otherwise, in the environment. The selected action can be taken by the reinforcement learning agent in the environment in any suitable manner in some embodiments.

Next, at 112, process 100 can determine a new state in the environment and a reinforcement learning “return” value. This return value is based on a reinforcement learning reward value associated with taking the selected action and the new state, and/or any other suitable values, in some embodiments. In some embodiments, any action selection received from an expert can have a negative associated reward in order to discourage calling an expert unless necessary. This determination can be made in any suitable manner in some embodiments.

Then, at 114, process 100 can update policy 120 based on the action taken at 110, the new state determined at 112, and/or the return value determined at 112 according to a reinforcement learning training mechanism. Any suitable reinforcement learning training mechanism can be used in some embodiments. For example, in some embodiments the Duelling Deep Q network reinforcement learning training mechanism can be used in some embodiments. For example, in some embodiments, an actor-critic reinforcement learning training mechanism can be used in some embodiments.

At 116, process 100 can next determine if it is done at 116. This determination can be made in any suitable manner in some embodiments. For example, this determination can be made based upon a predetermined number of actions (e.g., 10 M) having been performed in some embodiments.

If it is determined at 116 that process 100 is done, then the process can terminate at 118. Otherwise, if it is determined at 116 that process 100 is not done, then process 100 can loop back to 104.

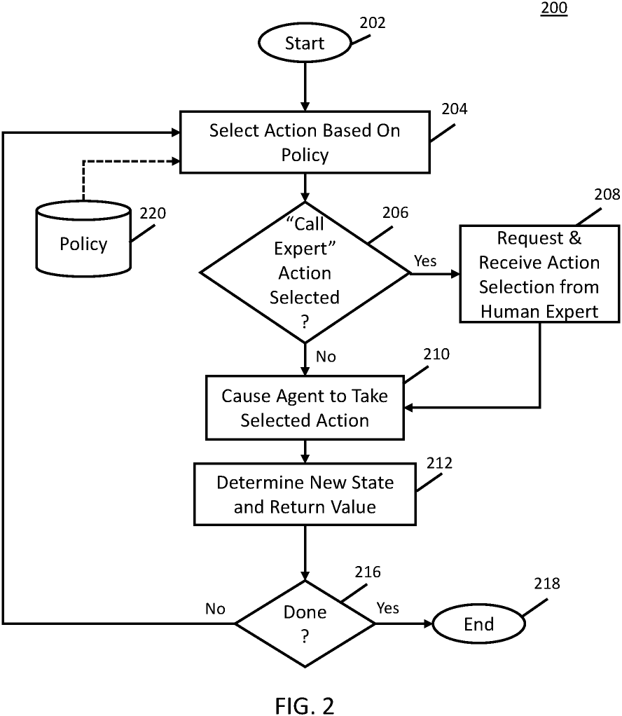

Turning to FIG. 2, an example 200 of a process for run-time selecting and taking of actions by a reinforcement learning agent according to the reinforcement learning policy trained in FIG. 1 in accordance with some embodiments is illustrated. As can be seen, process 200 is very similar to process 100 except that it does not include updating a policy as shown in FIG. 1 at 114. Accordingly, 202, 204, 206, 208, 210, and 212 of process 200 can be implemented similarly and/or identically as described above in connection with 102, 104, 106, 108, 110, and 112 of process 100, in some embodiments. Likewise, policy 200 can be similar to, or the same as, policy 100 of FIG. 1.

At 216 of FIG. 2, process 200 can next determine if it is done. This determination can be made in any suitable manner in some embodiments. For example, this determination can be made based upon whether a reinforcement learning agent has reached a termination point (whether with a desired or undesired final state) according to any suitable criteria or criterion, in some embodiments.

If it is determined at 216 that process 200 is done, then the process can terminate at 218. Otherwise, if it is determined at 216 that process 200 is not done, then process 200 can loop back to 204.

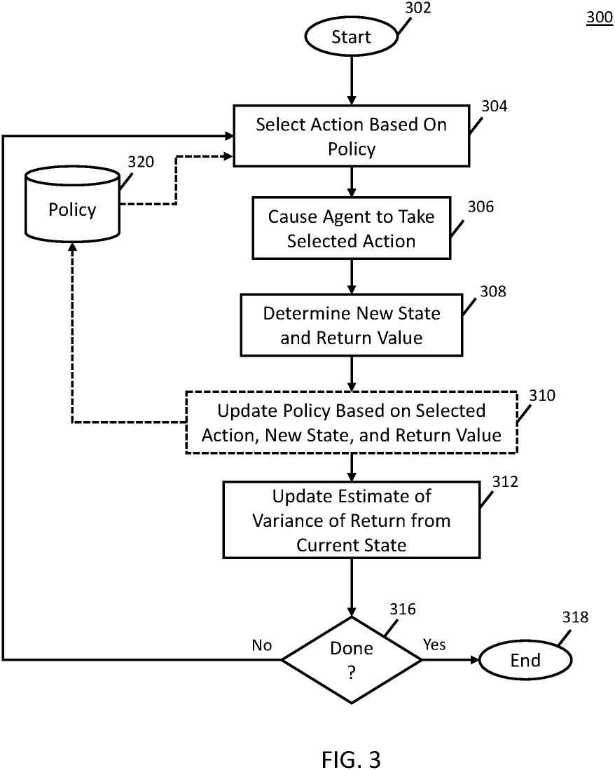

Turning to FIG. 3, an example 300 of another process for training a reinforcement learning policy in accordance with some embodiments is illustrated. As shown, after process 300 begins at 302, the process selects an action to be taken by a reinforcement learning agent based on a current state of an environment in which the agent is present according to a policy 320 at 304. Any suitable action can be selected in accordance with policy 320, and any suitable policy 320 can be used (e.g., such as a manually defined initial policy), in some embodiments. In some embodiments, unlike process 100 of FIG. 1, the actions that can be selected at 304 in FIG. 3 do not include an action to “call expert”.

Next, at 306, process 300 can cause the agent to take the selected action in the environment. The selected action can be taken by the agent in the environment in any suitable manner in some embodiments.

Then, at 308, process 300 can determine a new state in the environment and a reinforcement learning “return” value. This return value can be based on a reinforcement learning reward value associated with taking the selected action and the new state, and/or any other suitable values. This determination can be made in any suitable manner in some embodiments.

At 310, process 300 can next update policy 320 based on the action taken at 306, the new state determined at 308, and/or the return value determined at 308 according to a reinforcement learning training mechanism. Any suitable reinforcement learning training mechanism can be used in some embodiments. For example, in some embodiments the Duelling Deep Q network reinforcement learning training mechanism can be used in some embodiments. For example, in some embodiments, an actor-critic reinforcement learning training mechanism can be used in some embodiments.

Next, at 312, process 300 can update an estimate of the variance of the return from the current state (i.e., the state just prior to taking the selected action at 306). This estimate can be updated in any suitable manner.

For example, in some embodiments, the estimate of the variance of the return from the current state can be updated based on known Monte-Carlo methods. More particularly, for example, in some embodiments, Monte-Carlo methods can be used to accumulate states and actions that process 300 takes and resulting rewards in a buffer and, at the end of an episode, calculate returns corresponding to the (state, action) pair. Using simple statistics, one can calculate variance for each state-action pair throughout the training.

As another example, in some embodiments, the estimate of the variance of the return from the current state can be updated based on the following equations:

$$\begin{matrix}{Q}_{t} \left(s , a\right) = {Q}_{t - 1} \left(s , a\right) + {α}_{q} \left[r \left(s , a\right) + γ * a r g m a {x}_{a} \left({Q}_{t - 1} \left(s ′ , a ′\right)\right) -\right) \\ \left({Q}_{t - 1} \left(s , a\right)\right]\end{matrix}$$

$$\begin{matrix}{M}_{t} \left(s , a\right) = {M}_{t - 1} \left(s , a\right) + {α}_{m} \left[r {\left(s , a\right)}^{2} + 2 γ r \left(s , a\right) *\right) \\ \left(a r g m a {x}_{a} \left({Q}_{t - 1} \left(s ′ , a ′\right)\right) + {γ}^{2} {M}_{t - 1} \left(s ′ , a ′\right) - {M}_{t - 1} \left(s , a\right)\right]\end{matrix}$$

$${V}_{t} \left(s , a\right) = {V}_{t - 1} \left(s , a\right) + {α}_{v} \left[{M}_{t} \left(s , a\right) - {Q}^{2} {}_{t} \left(s , a\right) - {V}_{t - 1} \left(s , a\right)\right]$$

where:
s is the state of agent before the step;
a is the action taken by agent in state s;
s′ is the state of agent after taking action a from state;
a′ is the action from state s′ as dictated by policy;
r(s, a) is the reward obtained by taking action a from state s;
aᵥ is the learning rate for variance (e.g., 0.1 or any other suitable value in some embodiments);
a_{q} is the learning rate for action-value (e.g., 0.1 or any other suitable value in some embodiments);
aₘ is the learning rate for second moment (e.g., 0.1 or any other suitable value in some embodiments);
γ is the discount factor (e.g., 0.9 or any other suitable value in some embodiments);
Qt(s, a) is the action value for (s, a) at time t after the update;
Q_{t -} i(s, a) is the action value for (s, a) at time t-1 before the update;
Mt(s, a) is the Second moment of the returns for (s, a) at time t after the update;
Mₜ₋₁(s, a) is the Second moment of the returns for at time t-1 before the update;
Vt-i(s, a) is the Variance of returns for (s, a) before making the update; and
Vt(s, a) is the Variance of returns for (s, a) after making the update.

At 316, process 300 can next determine if it is done at 316. This determination can be made in any suitable manner in some embodiments. For example, this determination can be made based upon a predetermined number of actions (e.g., 10 M) having been performed in some embodiments.

If it is determined at 316 that process 300 is done, then the process can terminate at 318. Otherwise, if it is determined at 316 that process 300 is not done, then process 300 can loop back to 304.

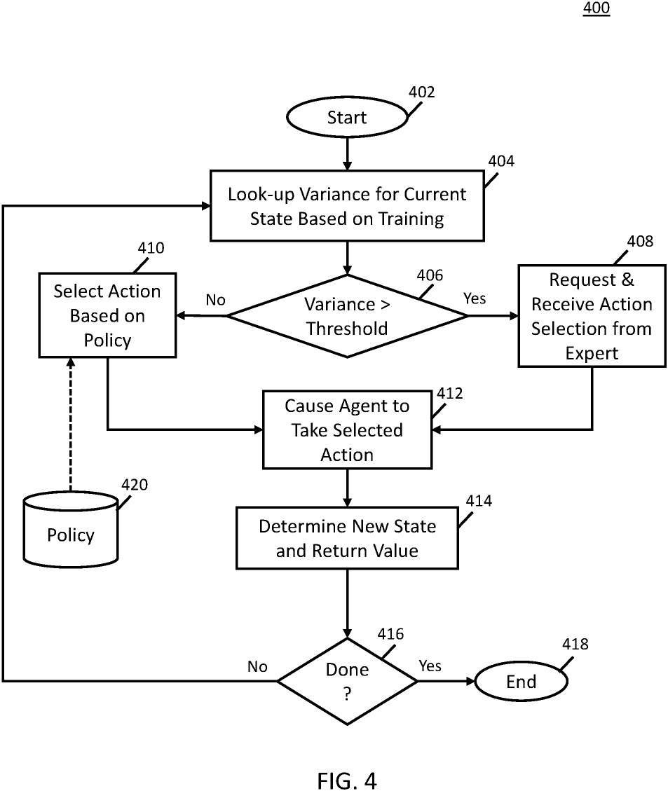

Turning to FIG. 4, an example 400 of a process for run-time selecting and taking of actions by a reinforcement learning agent according to the reinforcement learning policy trained in FIG. 3 in accordance with some embodiments is illustrated. As shown, after process 400 begins at 402, the process looks-up a variance for a current state in an environment based on training performed according to process 300 of FIG. 3. Looking-up the variance can be performed in any suitable manner in some embodiments.

Next, at 406, process 400 can determine if the variance for the current state is greater than (or greater than or equal to) a threshold. Any suitable threshold can be used in some embodiments. This determination can be made in any suitable manner in some embodiments.

If the variance for the current state is determined at 406 to be greater than (or greater than or equal to) the threshold, then at 408, process 100 can request and receive a new action selection of an action to be taken by the agent from a human expert. This request and receipt can be performed in any suitable manner in some embodiments. For example, in some embodiments, information on the current state of the environment, past states of the environment, policy information, available actions, and/or any other suitable information can be provided to a human expert via any suitable mechanism (e.g., help desk software), the human expert can select one of the available actions via any suitable mechanism (e.g., help desk software), after which an identification of the new selected action can be returned to process 400 for receipt.

If the variance for the current state is determined at 406 to be not greater than (or not greater than or equal to) the threshold, then at 410, process 400 can select an action to be taken by the agent based on a current state of an environment according to a policy 420. Any suitable action can be selected in accordance with policy 420, and any suitable policy 420 can be used, in some embodiments. In some embodiments, unlike selecting an action at 104 of FIG. 1, selecting an action at 410 cannot result in a “call expert” action being selected.

After receiving an action selection from an expert at 408 or selecting an action based on policy 420 at 410, process 400 can then cause the agent to take the selected action in the environment at 412. The selected action can be taken by the agent in the environment in any suitable manner in some embodiments.

At 414, process 400 can next determine a new state in the environment and a reinforcement learning “return” value. This return value can be based on a reinforcement learning reward value associated with taking the selected action and the new state, and/or any other suitable values. In some embodiments, any action selection received from an expert can have a negative associated reward in order to discourage calling an expert unless necessary. This determination can be made in any suitable manner in some embodiments.

Then, at 416, process 400 can next determine if it is done. This determination can be made in any suitable manner in some embodiments. For example, this determination can be made based upon whether a reinforcement learning agent has reached a termination point (whether with a desired or undesired final state) according to any suitable criteria or criterion, in some embodiments.

If it is determined at 416 that process 400 is done, then the process can terminate at 418. Otherwise, if it is determined at 416 that process 400 is not done, then process 400 can loop back to 404.

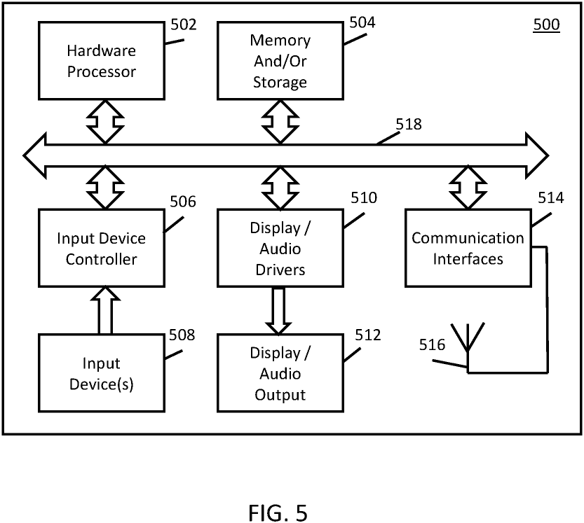

The processes of FIGS. 1-4 can be performed in any suitable general-purpose computer or special-purpose computer that can include any suitable hardware. For example, as illustrated in example hardware 500 of FIG. 5, such hardware can include hardware processor 502, memory and/or storage 504, an input device controller 506, an input device 508, display/audio drivers 510, display and audio output circuitry 512, communication interface(s) 514, an antenna 516, and a bus 518. Such a general-purpose computer or special-purpose computer can control the operation of any suitable device, such as an automated vehicle, a robot, or any other suitable device or system, in some embodiments.

Hardware processor 502 can include any suitable hardware processor, such as a microprocessor, a micro-controller, digital signal processor(s), dedicated logic, and/or any other suitable circuitry for controlling the functioning of a general-purpose computer or a special purpose computer in some embodiments.

Memory and/or storage 504 can be any suitable memory and/or storage for storing programs, data, and/or any other suitable information in some embodiments. For example, memory and/or storage 504 can include random access memory, read-only memory, flash memory, hard disk storage, optical media, and/or any other suitable memory.

Input device controller 506 can be any suitable circuitry for controlling and receiving input from input device(s) 508 in some embodiments. For example, input device controller 506 can be circuitry for receiving input from an input device 508, such as a touch screen, from one or more buttons, from a voice recognition circuit, from a microphone, from a camera, from an optical sensor, from an accelerometer, from a temperature sensor, from a near field sensor, and/or any other type of input device.

Display/audio drivers 510 can be any suitable circuitry for controlling and driving output to one or more display/audio output circuitries 512 in some embodiments. For example, display/audio drivers 510 can be circuitry for driving one or more display/audio output circuitries 512, such as an LCD display, a speaker, an LED, or any other type of output device.

Communication interface(s) 514 can be any suitable circuitry for interfacing with one or more communication networks, such as the Internet, a local area network, a wide area network, etc. For example, interface(s) 514 can include network interface card circuitry, wireless communication circuitry, and/or any other suitable type of communication network circuitry.

Antenna 516 can be any suitable one or more antennas for wirelessly communicating with a communication network in some embodiments. In some embodiments, antenna 516 can be omitted when not needed.

Bus 518 can be any suitable mechanism for communicating between two or more components 502, 504, 506, 510, and 514 in some embodiments.

Any other suitable components can additionally or alternatively be included in hardware 200 in accordance with some embodiments.

It should be understood that at least some of the above-described blocks of the processes of FIGS. 1-4 can be executed or performed in any order or sequence not limited to the order and sequence shown in and described in the figures. Also, some of the above blocks of the processes of FIGS. 1-4 can be executed or performed substantially simultaneously where appropriate or in parallel to reduce latency and processing times. Additionally or alternatively, some of the above described blocks of the processes of FIGS. 1-4 can be omitted.

In some embodiments, any suitable computer readable media can be used for storing instructions for performing the functions and/or processes described herein. For example, in some embodiments, computer readable media can be transitory or non-transitory. For example, non-transitory computer readable media can include media such as non-transitory magnetic media (such as hard disks, floppy disks, and/or any other suitable magnetic media), non-transitory optical media (such as compact discs, digital video discs, Blu-ray discs, and/or any other suitable optical media), non-transitory semiconductor media (such as flash memory, electrically programmable read-only memory (EPROM), electrically erasable programmable read-only memory (EEPROM), and/or any other suitable semiconductor media), any suitable media that is not fleeting or devoid of any semblance of permanence during transmission, and/or any suitable tangible media. As another example, transitory computer readable media can include signals on networks, in wires, conductors, optical fibers, circuits, any suitable media that is fleeting and devoid of any semblance of permanence during transmission, and/or any suitable intangible media.

Although the invention has been described and illustrated in the foregoing illustrative embodiments, it is understood that the present disclosure has been made only by way of example, and that numerous changes in the details of implementation of the invention can be made without departing from the spirit and scope of the invention, which is limited only by the claims that follow. Features of the disclosed embodiments can be combined and rearranged in various ways.

What is claimed is:

1. A system for selecting an action to be taken by a reinforcement learning agent in an environment, comprising:
a memory; and
a hardware processor coupled to the memory and configured to at least:
determine a first variance for a first state of the environment, wherein the first variance is based on reinforcement learning;
determine that the first variance meets a threshold;
in response to determining that the first variance meets the threshold:
request an identification of a first action to be taken by the agent from a human; and
receive the identification of the first action; and
cause the first action to be taken by the agent.

2. The system of claim 1, wherein the hardware processor is also configured to:
determine a second variance for a second state of the environment, wherein the second variance is based on reinforcement learning;
determine that the second variance does not meet the threshold;
in response to determining that the second variance does not meet the threshold: select a second action to be taken by the agent based on a reinforcement learning policy; and
cause the second action to be taken by the agent.

3. The system of claim 1, wherein the agent is an autonomous vehicle.

4. The system of claim 1, wherein the agent is a robot.

5. A system for selecting an action to be taken by a reinforcement learning agent in an environment, comprising:
a memory; and
a hardware processor coupled to the memory and configured to at least:
select a first action to be taken by the agent based on a reinforcement learning policy;
determine that the first action is to request an action selection from a human;
in response to determining that the first action is to request an action selection from a human:
request an identification of a new first action to be taken by the agent from a human; and
receive the identification of the new first action; and
cause the new first action to be taken by the agent.

6. The system of claim 5, wherein the hardware processor is also configured to:
select a second action to be taken by the agent based on the reinforcement learning policy;
determine that the second action is not to request an action selection from a human;
in response to determining that the second action is not to request an action selection from a human: cause the second action to be taken by the agent.

7. The system of claim 5, wherein the agent is one of an autonomous vehicle and a robot.

8. A method for selecting an action to be taken by a reinforcement learning agent in an environment, comprising:
determining a first variance for a first state of the environment, wherein the first variance is based on reinforcement learning using a hardware processor;
determining that the first variance meets a threshold;
in response to determining that the first variance meets the threshold:
requesting an identification of a first action to be taken by the agent from a human; and
receiving the identification of the first action; and
causing the first action to be taken by the agent.

9. The method of claim 8, further comprising:
determining a second variance for a second state of the environment, wherein the second variance is based on reinforcement learning;
determining that the second variance does not meet the threshold;
in response to determining that the second variance does not meet the threshold: selecting a second action to be taken by the agent based on a reinforcement learning policy; and
causing the second action to be taken by the agent.

10. The method of claim 8, wherein the agent is an autonomous vehicle.

11. The method of claim 8, wherein the agent is a robot.

12. A method for selecting an action to be taken by a reinforcement learning agent in an environment, comprising:
selecting a first action to be taken by the agent based on a reinforcement learning policy using a hardware processor;
determining that the first action is to request an action selection from a human;
in response to determining that the first action is to request an action selection from a human:
requesting an identification of a new first action to be taken by the agent from a human; and
receiving the identification of the new first action; and
causing the new first action to be taken by the agent.

13. The method of claim 12, further comprising:
selecting a second action to be taken by the agent based on the reinforcement learning policy;
determining that the second action is not to request an action selection from a human;
in response to determining that the second action is not to request an action selection from a human: causing the second action to be taken by the agent.

14. The method of claim 12, wherein the agent is one of an autonomous vehicle and a robot.

15. A non-transitory computer-readable medium containing computer executable instructions that, when executed by a processor, cause the processor to perform a method for selecting an action to be taken by a reinforcement learning agent in an environment, the method comprising:
determining a first variance for a first state of the environment, wherein the first variance is based on reinforcement learning;
determining that the first variance meets a threshold;
in response to determining that the first variance meets the threshold:
requesting an identification of a first action to be taken by the agent from a human; and
receiving the identification of the first action; and
causing the first action to be taken by the agent.

16. The non-transitory computer-readable medium of claim 15, where the method further comprises:
determining a second variance for a second state of the environment, wherein the second variance is based on reinforcement learning;
determining that the second variance does not meet the threshold;
in response to determining that the second variance does not meet the threshold: selecting a second action to be taken by the agent based on a reinforcement learning policy; and
causing the second action to be taken by the agent.

17. The non-transitory computer-readable medium of claim 15, wherein the agent is an autonomous vehicle.

18. The non-transitory computer-readable medium of claim 15, wherein the agent is a robot.

19. A non-transitory computer-readable medium containing computer executable instructions that, when executed by a processor, cause the processor to perform a method for selecting an action to be taken by a reinforcement learning agent in an environment, the method comprising:
selecting a first action to be taken by the agent based on a reinforcement learning policy;
determining that the first action is to request an action selection from a human;
in response to determining that the first action is to request an action selection from a human:
requesting an identification of a new first action to be taken by the agent from a human; and
receiving the identification of the new first action; and
causing the new first action to be taken by the agent.

20. The non-transitory computer-readable medium of claim 19, wherein the method further comprises:
selecting a second action to be taken by the agent based on the reinforcement learning policy;
determining that the second action is not to request an action selection from a human;
in response to determining that the second action is not to request an action selection from a human: causing the second action to be taken by the agent.

21. The non-transitory computer-readable medium of claim 19, wherein the agent is one of an autonomous vehicle and a robot.
